(19) United States
(12) Patent Application Publication
(10) Pub. No.: US 2026/0102838 A1
(43) Pub. Date: Apr. 16, 2026

(54) RESISTANCE SPOT WELDING DEVICE AND METHOD FOR VEHICLE ASSEMBLY

(71) Applicants: Hyundai Motor Company, Seoul (KR); Kia Corporation, Seoul (KR)

(72) Inventor: Seung Ho Lee, Hwaseong (KR)

(21) Appl. No.: 19/018,801

(22) Filed: Jan. 13, 2025

(30) Foreign Application Priority Data
Oct. 11, 2024 (KR) 10-2024-0138616

(51) Int. Cl. B23K 11/11

(52) U.S. Cl. CPC B23K 11/115

(57) ABSTRACT

A resistance spot welding device for vehicle assembly includes a welding gun having an upper electrode and a lower electrode mounted thereon, the upper electrode and the lower electrode facing each other, an adjustment jig for adjusting straightness between the upper electrode and the lower electrode, an image capturing apparatus mounted on the welding gun for photographing a welding surface, teaching blocks respectively mounted on a plurality of welding points formed on the welding surface, and a controller for calculating, through image information on each of the teaching blocks received from the image capturing apparatus, a rotation amount and a movement amount of the welding gun, and to perform a control operation to correct a welding position of the welding gun based on the calculated rotation amount and movement amount.

### CROSS-REFERENCE TO RELATED APPLICATION

This application claims under 35 U.S.C. § 119(a) the benefit of Korean Patent Application No. 10-2024-0138616, filed on Oct. 11, 2024, the entire contents of which are incorporated herein by reference.

### BACKGROUND

### (a) Technical Field

The present disclosure relates to a resistance spot welding device and a resistance spot welding method for vehicle assembly, more particularly, to the resistance spot welding device and method capable of securing straightness of a welding gun and providing a constant pressing force during welding, thereby preventing generation of spatter during a vehicle assembly process.

### (b) Description of the Related Art

In general, when using an electric resistance spot welding device during vehicle assembly, for example, a worker holds a welding specimen by hand or uses a specially manufactured dedicated jig configured to place the welding specimen on a lower electrode of the electric resistance spot welding device, thereby preparing welding work.

In this case, the upper body of the electric resistance spot welding device is moved upwards and downwards, and an upper electrode of the electric resistance spot welding device presses the welding specimen placed on the lower electrode. Here, when current flows through the upper and lower electrodes, resistance heat is generated and welding proceeds.

In this case, spatter (“molten fly ash” generated during welding) is generated due to the state of a material constituting the welding specimen, the fixed state of the welding specimen, or an excessive increase in the set current value.

Such spatter causes various adverse effects such as deterioration in completed vehicle quality and problems related to factory operation.

For example, first, spatter may reduce the thickness of a bonding material, leading to deterioration in rigidity of a completed vehicle. Further, since a welding chip caused by spatter is fixed on the outer plate of a vehicle body, the appearance quality of a completed vehicle may deteriorate.

Second, regarding factory operation, flying iron dust caused by spatter generation may contaminate the internal environment of the factory. For example, if sparks fly to a facility in the factory during welding, a fire may occur and may cause damage to the facility. As a result, the operation rate of the facility is lowered.

Third, in order to solve a problem related to spatter, management personnel and costs are excessively invested in welding quality control at a completed vehicle factory. As a result, profitability of the completed vehicle factory decreases.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a resistance spot welding device and a resistance spot welding method, e.g., for vehicle assembly, capable of securing straightness between an upper tip and a lower tip of a welding gun using an adjustment jig, correcting the position of the welding gun using a camera in a state in which a block is fixed to a panel, and performing welding in a state in which pressing force applied to the welding surface is equally applied to the upper tip and the lower tip through an air balance cylinder mounted on the welding gun such that balance of pressing force is maintained in the upper and lower tips, thereby having an effect of preventing spatter generation due to an increase in resistance heat caused by a change in pressing force.

In one aspect, the present disclosure provides a resistance spot welding device for vehicle assembly including: a welding gun; an adjustment jig configured to adjust positioning of the welding gun; an image capturing apparatus mounted on the welding gun and configured to photograph a welding surface; teaching blocks respectively mounted on a plurality of welding points formed on the welding surface; and a controller configured to calculate, through image information on each of the teaching blocks received from the image capturing apparatus, a rotation amount and a movement amount of the welding gun, and to perform a control operation to correct a welding position of the welding gun based on the calculated rotation amount and movement amount.

In certain embodiments of this resistance spot welding device, the welding gun may preferably comprise an upper electrode and a lower electrode, and the adjustment jig is configured to adjust straightness between the upper electrode and the lower.

In a further aspect, the present disclosure provides a resistance spot welding device (e.g., for vehicle assembly) including a welding gun having an upper electrode and a lower electrode mounted thereon, the upper electrode and the lower electrode facing each other, an adjustment jig configured to adjust straightness between the upper electrode and the lower electrode, an image capturing apparatus mounted on the welding gun and configured to photograph a welding surface, teaching blocks respectively mounted on a plurality of welding points formed on the welding surface, and a controller configured to calculate, through image information on each of the teaching blocks received from the image capturing apparatus, a rotation amount and a movement amount of the welding gun, and to perform a control operation to correct a welding position of the welding gun based on the calculated rotation amount and movement amount.

In a preferred embodiment, each of the teaching blocks may be formed to have a hexahedral shape including a reference surface positioned in a direction facing the image capturing apparatus and a mounting surface positioned at the welding point on the welding surface, and four side surfaces connecting the reference surface to the mounting surface may be respectively formed to have different pieces of color information.

In another preferred embodiment, the controller may be configured to perform, upon determining that any one of a first color and a second color facing each other on the side surfaces is included in the image information, a control operation to correct the welding position such that the welding gun is rotated about a +x-axis or a −x-axis relative to a center point of the reference surface.

In still another preferred embodiment, the controller may be configured to perform, upon determining that any one of a third color and a fourth color facing each other on the side surfaces is included in the image information, a control operation to correct the welding position such that the welding gun is rotated about a +y-axis or a −y-axis relative to the center point of the reference surface.

In yet another preferred embodiment, the controller may be configured to perform, upon determining that a shape of a center point formed on the reference surface includes a guide area such that the guide area is rotated from a set initial position, position correction such that the welding gun is rotated about a +z-axis or a −z-axis.

In still yet another preferred embodiment, the controller may be configured to calculate a length ratio by comparing a measurement length between protrusions respectively formed at opposite corners on the reference surface with a reference measurement length, and to correct, using the calculated length ratio, an upward movement position or a downward movement position of the welding gun.

In a further preferred embodiment, the adjustment jig may include a first fixing part configured to fix an electrode tip of the lower electrode, and a second fixing part configured to allow an electrode tip of the upper electrode to be introduced thereinto in a state in which the electrode tip of the lower electrode is fixed to the first fixing part, wherein the second fixing part may be configured to adjust, based on determination of presence or absence of interference between the electrode tip of the upper electrode and the second fixing part, the straightness between the upper electrode and the lower electrode.

In another further preferred embodiment, the controller may be configured to control, when the upper electrode is moved downwards, pneumatic pressure supplied to a balance cylinder so as to apply preset gravitational force to the welding surface, and to cause, when the welding gun including the lower electrode is moved upwards, reaction force equal to the preset gravitational force to be applied to the welding surface.

In still another further preferred embodiment, the resistance spot welding device may further include a straightness inspection jig introduced into the welding gun in a state in which the welding point is completely welded, the straightness inspection jig being configured to inspect the straightness between the upper electrode and the lower electrode.

In yet another further preferred embodiment, the straightness inspection jig may include a first mounting part formed to be rotatable, the first mounting part having a first through hole provided therein and configured to allow an electrode tip of the upper electrode to pass therethrough, a second mounting part disposed to face the first mounting part and formed to be rotatable, the second mounting part having a second through hole positioned to extend in a vertical direction from the first through hole, the second through hole being configured to allow an electrode tip of the lower electrode to pass therethrough, a first sensor part configured to provide, depending on selective rotation of the first mounting part, a signal about poor straightness of the upper electrode, and a second sensor part configured to provide, depending on selective rotation of the second mounting part, a signal about poor straightness of the lower electrode.

In another aspect, the present disclosure provides a resistance spot welding method (e.g., for vehicle assembly) including a straightness adjustment step of adjusting, by an adjustment jig, straightness between an upper electrode and a lower electrode each forming a welding gun, a welding gun position correction step of mounting a teaching block on a welding point formed on a welding surface when the straightness between the upper electrode and the lower electrode is determined to be satisfied, and calculating, by a controller, a rotation amount and a movement amount of the welding gun through image information on the teaching block received from an image capturing apparatus so as to correct a welding position of the welding gun, a welding point position comparison step of comparing, when the corrected welding position of the welding gun is transmitted to the controller, a difference between the welding position and a reference welding position previously stored in the controller, and a welding step of controlling, by the controller, the welding gun when the welding position and the reference welding position coincide with each other and performing welding on the welding point.

In a preferred embodiment, the straightness adjustment step may include a first step of fixing an electrode tip of the lower electrode through a first fixing part formed on one side of the adjustment jig, and a second step of allowing an electrode tip of the upper electrode to be introduced into a second fixing part formed on the other side of the adjustment jig in a state in which the electrode tip of the lower electrode is fixed to the first fixing part, and adjusting, based on determination of presence or absence of interference between the electrode tip of the upper electrode and the second fixing part, the straightness between the upper electrode and the lower electrode.

In another preferred embodiment, in the welding gun position correction step, the teaching block may be formed to have a hexahedral shape including a reference surface positioned in a direction facing the image capturing apparatus and a mounting surface positioned at the welding point on the welding surface, and the controller may correct the rotation amount of the welding gun using different pieces of color information respectively included in four side surfaces of the teaching block.

In still another preferred embodiment, in the welding gun position correction step, the controller may be configured to perform, upon determining that any one of a first color and a second color facing each other on the side surfaces is included in the image information, position correction such that the welding gun is rotated about a +x-axis or a −x-axis relative to a center point of the reference surface.

In yet another preferred embodiment, in the welding gun position correction step, the controller may be configured to perform, upon determining that any one of a third color and a fourth color facing each other on the side surfaces is included in the image information, position correction such that the welding gun is rotated about a +y-axis or a −y-axis relative to the center point of the reference surface.

In still yet another preferred embodiment, in the welding gun position correction step, the controller may be configured to perform, upon determining that a shape of a center point formed on the reference surface includes a guide area such that the guide area is rotated from a set initial position, position correction such that the welding gun is rotated about a +z-axis or a −z-axis.

In a further preferred embodiment, in the welding gun position correction step, the controller may be configured to calculate a length ratio by comparing a measurement length between protrusions respectively formed at opposite corners on the reference surface with a reference measurement length, and to correct, using the calculated length ratio, an upward movement position or a downward movement position of the welding gun.

In another further preferred embodiment, the resistance spot welding method may further include a straightness inspection step of inspecting, using a straightness inspection jig inserted into the welding gun, the straightness between the upper electrode and the lower electrode in a state in which the welding point is completely welded.

In still another further preferred embodiment, in the straightness inspection step, an electrode tip of the upper electrode may be allowed to pass through a first through hole of a first mounting part, and the straightness inspection jig may provide, when the first mounting part is rotated and disposed to face a first sensor part, a signal about poor straightness of the upper electrode.

In yet another further preferred embodiment, in the straightness inspection step, an electrode tip of the lower electrode may be allowed to pass through a second through hole of a second mounting part, and the straightness inspection jig may provide, when the second mounting part is rotated and disposed to face a second sensor part, a signal about poor straightness of the lower electrode.

A vehicle assembly process may include the resistance spot welding method.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a drawing showing a configuration of a resistance spot welding device according to an embodiment of the present disclosure;

FIGS. 2A and 2B are a drawing showing an adjustment jig of the resistance spot welding device according to the embodiment of the present disclosure;

FIGS. 3A and 3B are diagrams each showing welding position correction of the resistance spot welding device according to the embodiment of the present disclosure;

FIG. 4 is a drawing showing a welding gun of the resistance spot welding device according to the embodiment of the present disclosure;

FIG. 5 is a drawing showing a teaching block of the resistance spot welding device according to the embodiment of the present disclosure;

FIGS. 6A to 6C are drawings each showing correction of the x-axis welding position of the resistance spot welding device according to the embodiment of the present disclosure;

FIGS. 7A to 7C are drawings each showing correction of the y-axis welding position of the resistance spot welding device according to the embodiment of the present disclosure;

FIGS. 8A to 8C are drawings each showing correction of the z-axis rotation and height of the resistance spot welding device according to the embodiment of the present disclosure;

FIG. 9 is a drawing showing a structure of the welding gun of the resistance spot welding device according to the embodiment of the present disclosure;

FIGS. 10A to 10C are drawings each showing a bidirectional pressurizing structure of the resistance spot welding device according to the embodiment of the present disclosure;

FIGS. 11A and 11B are drawings each showing a straightness inspection jig of the resistance spot welding device according to the embodiment of the present disclosure;

FIG. 12 is a flowchart sequentially showing a resistance spot welding method according to another embodiment of the present disclosure; and

FIG. 13 is a flowchart sequentially showing correction of the welding position in the resistance spot welding method according to another embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to various embodiments of the present disclosure, examples of which are illustrated in the accompanying drawings and described below.

Advantages and features of the present disclosure and methods of achieving the same will become more apparent with reference to the embodiments described below in detail and the accompanying drawings.

However, the present disclosure is not limited by the embodiments disclosed below, and may be implemented in various forms. The embodiments are provided to ensure that the disclosure of the present disclosure is complete, and to fully inform the scope of the disclosure to those skilled in the art to which the present disclosure pertains, and the present disclosure is only defined by the scope of the claims.

In describing the embodiments disclosed herein, when it is determined that a detailed description of publicly known techniques to which the disclosure pertains may obscure the gist of the present disclosure, the detailed description thereof will be omitted.

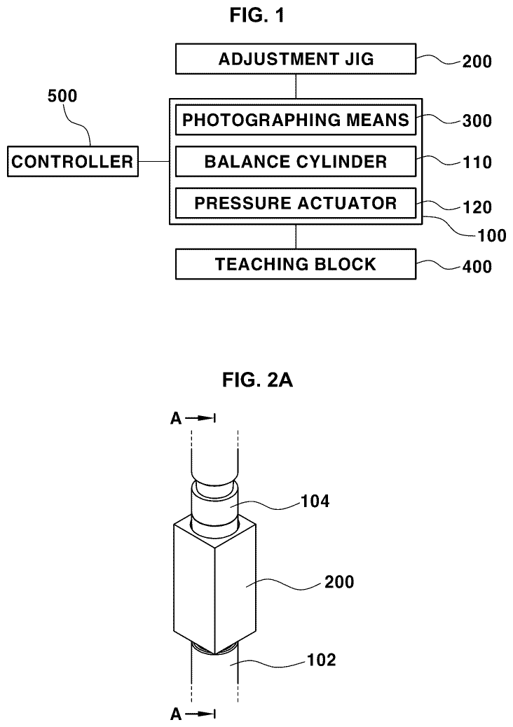

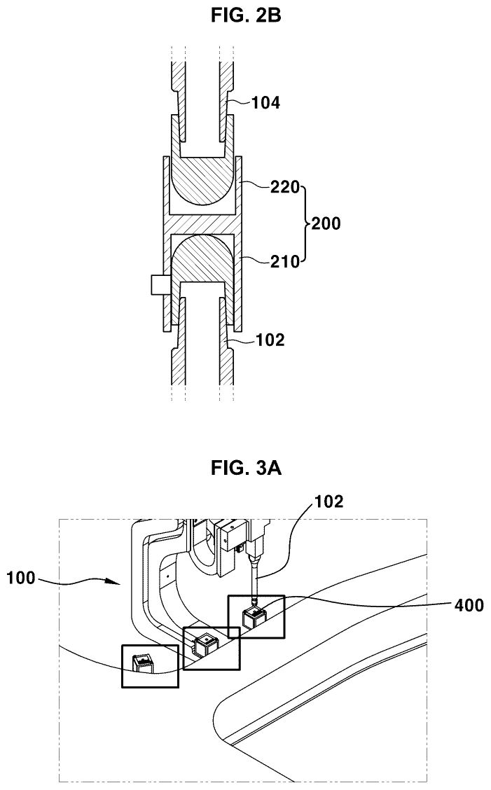

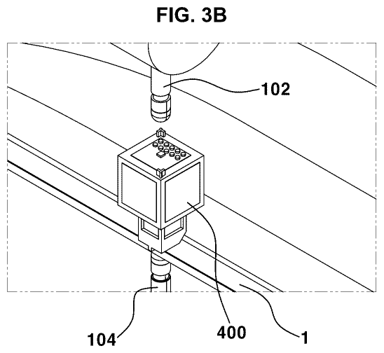

FIG. 1 is a drawing showing a configuration of a resistance spot welding device according to an embodiment of the present disclosure, FIGS. 2A and 2B are a drawing showing an adjustment jig of the resistance spot welding device according to the embodiment of the present disclosure, and FIGS. 3A and 3B are diagrams each showing welding position correction of the resistance spot welding device according to the embodiment of the present disclosure.

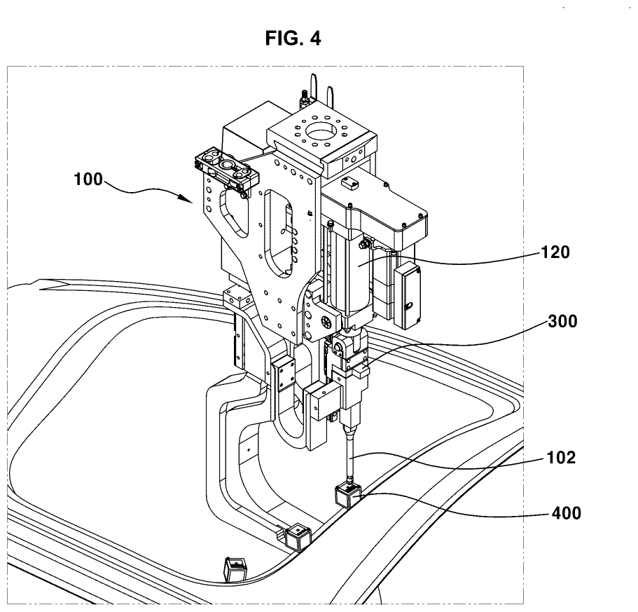

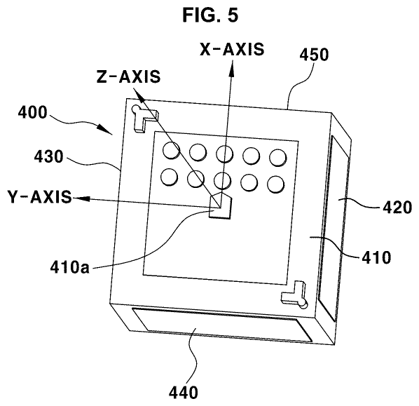

FIG. 4 is a drawing showing a welding gun of the resistance spot welding device according to the embodiment of the present disclosure, and FIG. 5 is a drawing showing a teaching block of the resistance spot welding device according to the embodiment of the present disclosure.

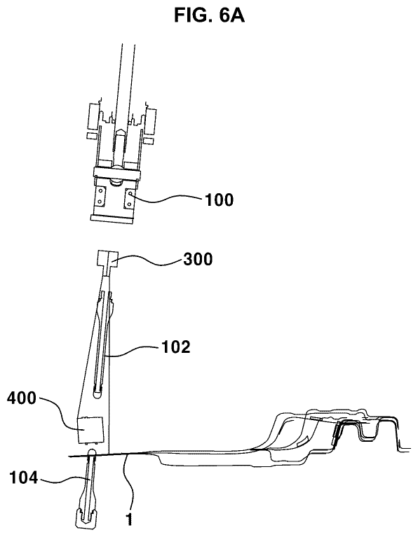

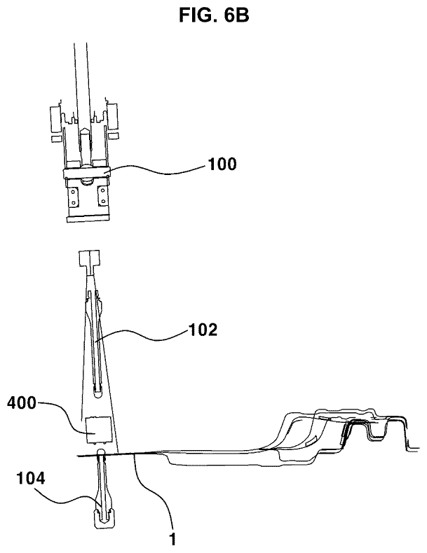

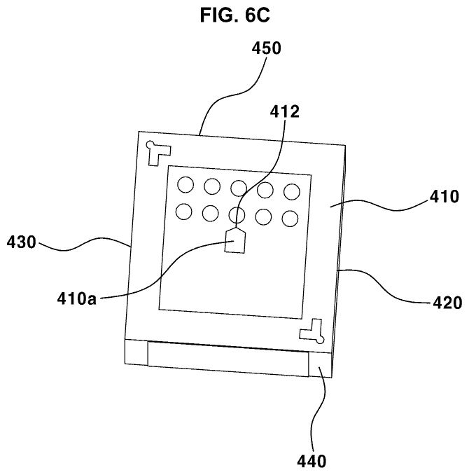

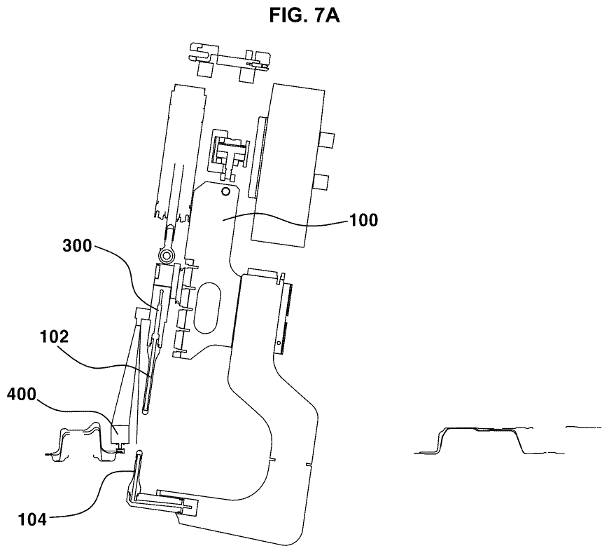

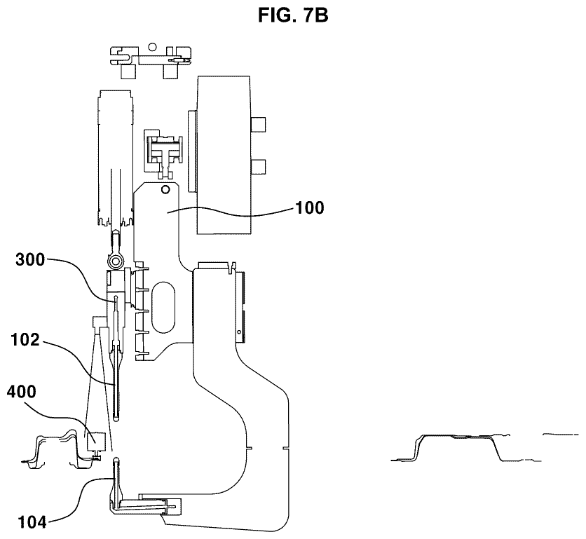

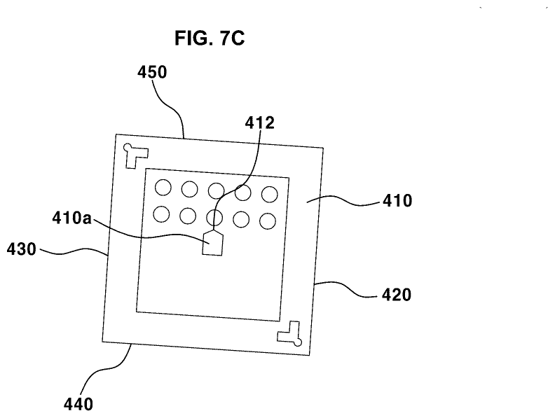

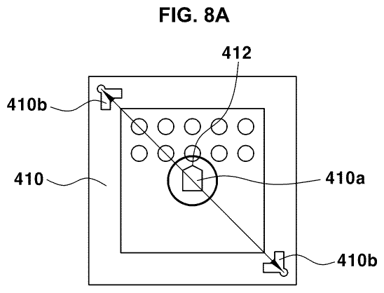

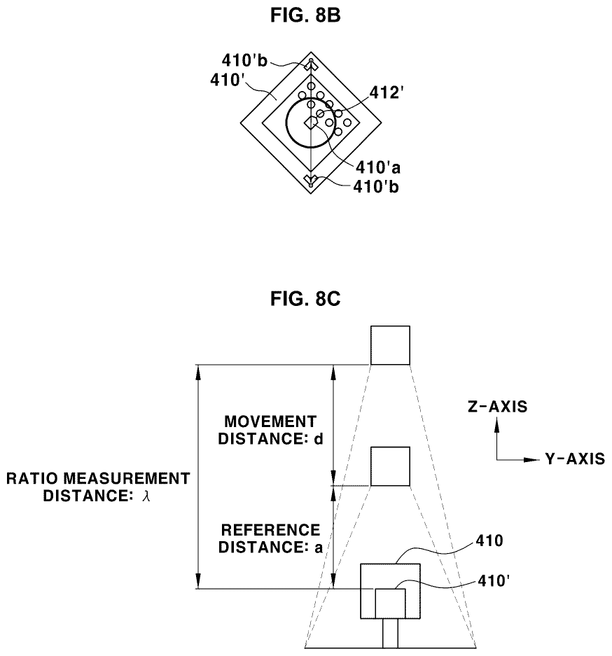

FIGS. 6A to 6C are drawings each showing correction of the x-axis welding position of the resistance spot welding device according to the embodiment of the present disclosure, FIGS. 7A to 7C are drawings each showing correction of the y-axis welding position of the resistance spot welding device according to the embodiment of the present disclosure, and FIGS. 8A to 8C are drawings each showing correction of the z-axis rotation and height of the resistance spot welding device according to the embodiment of the present disclosure.

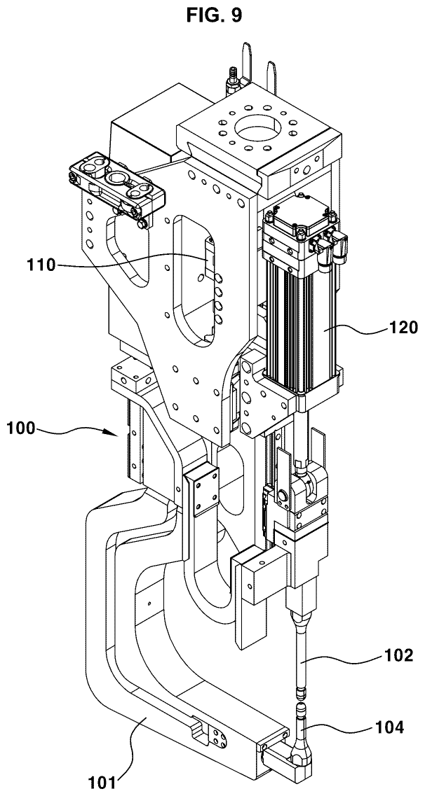

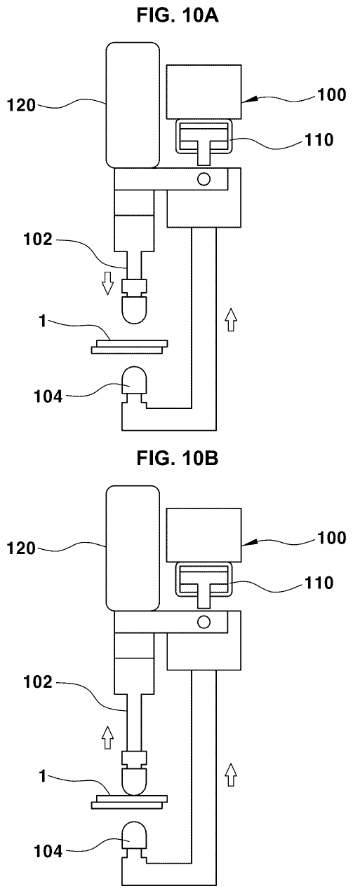

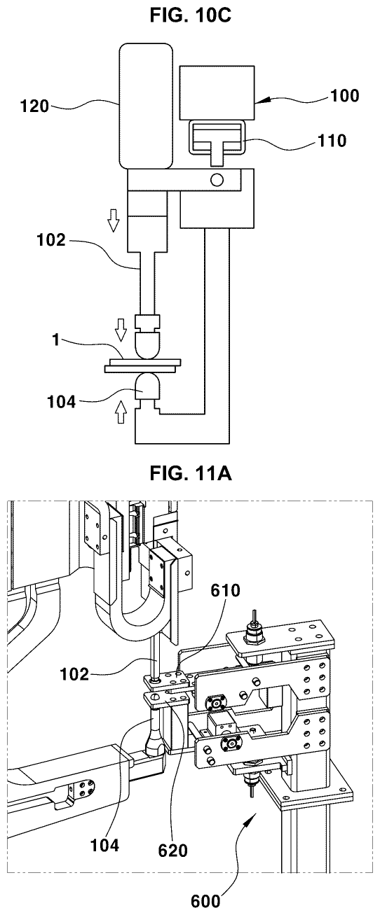

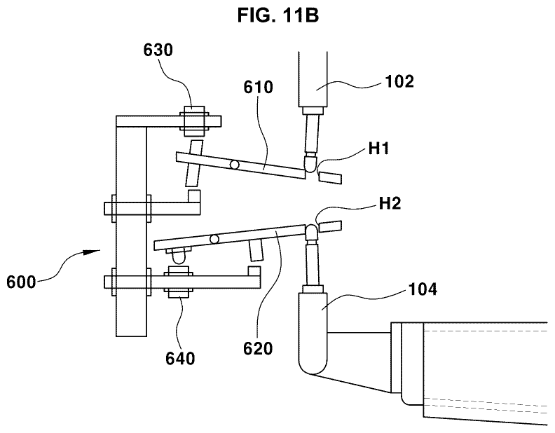

FIG. 9 is a drawing showing a structure of the welding gun of the resistance spot welding device according to the embodiment of the present disclosure, FIGS. 10A to 10C are drawings each showing a bidirectional pressurizing structure of the resistance spot welding device according to the embodiment of the present disclosure, and FIGS. 11A and 11B are drawings each showing a straightness inspection jig of the resistance spot welding device according to the embodiment of the present disclosure.

Normally, spatter is generated due to various causes during resistance spot welding. Spatter generation is mainly caused by insufficient welding pressing force and a change in welding pressing force during welding.

More specifically, during welding, a steel/aluminum material melts due to high resistance heat and changes into liquid. At this time, a phase change from solid to liquid occurs, and its density increases. Due to this increase in density, the pressure inside a nugget increases, and the high pressure generates force that causes molten metal inside the nugget to be ejected or scattered to the outside.

That is, welding spatter is formed by droplets of molten material ejected from the nugget to the outside and causes a welding defect formed on the metal surface. In order to prevent generation of welding spatter, straightness of a welding gun needs to be secured during welding, and sufficient and constant pressing force needs to be applied to a welding target.

To this end, as shown in FIG. 1, the resistance spot welding device according to the present embodiment includes a welding gun 100, an adjustment jig 200, an image capturing apparatus 300, a teaching block 400, and a controller 500.

The welding gun 100 includes an upper electrode 102 and a lower electrode 104 mounted thereon in a state of facing each other, thereby preventing spatter generation and enabling the upper and lower portions of the panel 1 to be joined to each other.

That is, the welding gun 100 includes the upper electrode 102 capable of being moved upwards and downwards by a pressure actuator 120, as shown in FIG. 9, and the lower electrode 104 fixedly mounted on a robot arm 101. When high current is generated between an electrode tip of the upper electrode 102 and an electrode tip of the lower electrode 104, high heat is generated due to high current and resistance of a matching part of the panel 1, and the panel 1 is melted and cooled, thereby allowing the upper and lower portions of the panel 1 to be joined to each other.

In the welding gun 100, since a balance cylinder 110 is controlled by the controller 500, gravitational force and reaction force respectively applied to the upper welding surface and the lower welding surface of the panel 1 may have the same force (refer to the arrow direction of FIG. 10C), and constant pressing force may be applied to the panel 1 by force balance between the upper electrode 102 and the lower electrode 104, thereby preventing spatter generation.

In other words, when the upper electrode 102 is moved downwards, the controller 500 may control pneumatic pressure supplied to the balance cylinder 110 such that preset gravitational force is applied to the welding surface, and while the welding gun 100 including the lower electrode 104 is moved upwards and downwards, reaction force corresponding to the preset gravitational force may be adjustably applied to the welding surface. For example, welding is performed in a state in which gravitational force of 250 kgf and reaction force of 250 kgf corresponding to the gravitational force are respectively applied to the upper portion and the lower portion of the panel 1, thereby making it possible to prevent spatter generation due to the provision of pressing force of 500 kgf.

More specifically, as shown in FIG. 10A, when an electric proportional control valve (not shown) is controlled by the controller 500 so as to allow air to be suctioned/exhausted through the balance cylinder 110 such that gravitational force is applied to the entire welding gun 100, the welding gun enters a no-load state in which the welding gun is movable upwards and downwards by a person.

At this time, as shown in FIG. 10B, when the upper electrode 102 is moved downwards to provide the set gravitational force to the panel 1 under the control of the pressure actuator 120 and contacts the panel 1, the entire welding gun 100 is moved upwards due to the reaction force generated when the upper electrode contacts the panel 1. Accordingly, as shown in FIG. 10C, welding may be performed in a state in which the pressure applied to the panel 1 is equally applied to the upper and lower portions of the panel by the law of conservation of energy and the mechanical principle, that is, in a force equilibrium state.

Therefore, in the present embodiment, welding is performed in a state in which the same force is constantly applied to the upper and lower portions of the panel 1 by the mechanical characteristics that provide gravitational force and reaction force corresponding to the gravitational force, thereby preventing deformation of the panel 1. Accordingly, spatter generation caused by excessive heat during welding may be prevented in advance.

Meanwhile, as shown in FIGS. 2A and 2B, the adjustment jig 200 adjusts straightness between the upper electrode 102 and the lower electrode 104.

The adjustment jig 200 is equipped with a first fixing part 210 and a second fixing part 220.

The first fixing part 210 fixes the electrode tip of the lower electrode 104.

In a state in which the electrode tip of the lower electrode 104 is fixed to the first fixing part 210, the second fixing part 220 determines, when the electrode tip of the upper electrode 102 is introduced into the second fixing part, presence or absence of interference between the electrode tip and the second fixing part and then adjusts the straightness.

This straightness adjustment is performed prior to welding. Specifically, the pressure actuator 120 is moved downwards in a state in which the electrode tip of the lower electrode 104 is inserted and fixed to the first fixing part 210 such that the electrode tip of the upper electrode 102 is positioned on the second fixing part 220 formed to be integrated with the first fixing part 210.

Here, when the electrode tip of the upper electrode 102 is positioned on the second fixing part 220 without interference between the electrode tip and the second fixing part, it is determined that straightness between the upper electrode 102 and the lower electrode 104 is satisfied. On the other hand, when interference therebetween occurs, the position of the electrode tip of the upper electrode 102 is adjusted so as to be positioned in a straight line with the electrode tip of the lower electrode 104.

When the electrode tip of the upper electrode 102 and the electrode tip of the lower electrode 104 are not positioned in a straight line, welding is performed in a state in which the electrode tip of the upper electrode 102 and the electrode tip of the lower electrode 104 are not aligned with each other. Therefore, it is required to adjust, through the adjustment jig 200, the positions of the electrode tip of the upper electrode 102 and the electrode tip of the lower electrode 104 so as to satisfy straightness between the upper electrode 102 and the lower electrode 104 before welding is performed, thereby making it possible to prevent spatter generation during welding.

As described above, straightness adjustment using the adjustment jig 200 may be performed prior to welding as described above, and the welding gun may be moved to the welding position in a state in which straightness between the upper electrode 102 and the lower electrode 104 is satisfied. Here, preferably, the adjustment jig 200 may be attached to a plurality of welding positions using a magnet or the like, and straightness between the upper electrode 102 and the lower electrode 104 may be adjusted in real time at the welding position. In this manner, straightness between the upper electrode 102 and the lower electrode 104 may be satisfied.

Meanwhile, as shown in FIG. 4, the image capturing apparatus 300 is mounted on the welding gun 100 to photograph the welding surface, and as shown in FIG. 5, a plurality of the teaching blocks 400 is provided and is mounted on each of the plurality of welding points formed on the welding surface.

As provided herein, the term “teaching block” refers to a structural element that includes certain information regarding the proper welding position of the welding gun 100, in order to prevent generation of splatter during a welding process. Preferably the information is provided on a surface of the teaching block 400 that faces the image capturing apparatus 300, so that such information is captured during the welding process.

The image capturing apparatus 300 may be equipped with a vision camera capable of performing wired/wireless communication and may transmit image information on the photographed welding surface to the controller 500.

The teaching block 400 is formed to have a cube shape including a reference surface 410 positioned in a direction facing the image capturing apparatus 300 and a mounting surface formed in the opposite direction to the reference surface 410 and fixed to the welding point of the welding surface.

The teaching blocks 400 may be respectively fixed to the plurality of welding points on the welding surface of the panel 1, as shown in FIG. 3A and FIG. 3B. Accordingly, it is possible to automatically secure and correct the welding position of the welding gun 100 through the teaching block, thereby preventing spatter generation.

Here, as described above, the welding position of the welding gun 100 may be automatically secured and corrected, but in order to reduce costs, a worker may also manually determine and adjust the welding position of the welding gun 100 with the naked eye.

To this end, the teaching block 400 is formed with different pieces of color information respectively included in four side surfaces 420, 430, 440, and 450 connecting the reference surface 410 to the mounting surface.

Accordingly, the controller 500 calculates the rotation amount and movement amount of the welding gun 100 through the image information on the reference surface 410 of the teaching block 400 received from the image capturing apparatus 300 so as to perform a control operation to correct the welding position of the welding gun 100.

That is, as shown in FIG. 6A, upon determining that a first color of the side surface 420, for example, purple color information, is exposed from the teaching block 400 with reference to the image information received from the image capturing apparatus 300 (refer to FIG. 5), the controller 500 performs a control operation to correct the rotation amount of the welding gun 100 with respect to the +x-axis.

Here, when the controller 500 corrects the rotation amount of the welding gun 100 with respect to the +x-axis, repetitive control may be performed. As shown in FIG. 6B, in a state in which the rotation amount of the welding gun 100 with respect to the +x-axis is corrected, upon determining that purple color information is not exposed from the teaching block 400 as a result of photographing the teaching block 400, as shown in FIG. 6C, the controller may determine that the rotation amount of the welding gun 100 with respect to the +x-axis has been completely corrected.

Further, as shown in FIG. 6A, upon determining that a second color of the side surface 430, for example, green color information, is exposed from the teaching block 400 with reference to the image information received from the image capturing apparatus 300 (refer to FIG. 5), the controller 500 performs a control operation to correct the rotation amount of the welding gun 100 with respect to the −x-axis.

Here, when the controller 500 corrects the rotation amount of the welding gun 100 with respect to the −x-axis, repetitive control may be performed. As shown in FIG. 6B, in a state in which the rotation amount of the welding gun 100 with respect to the −x-axis is corrected, upon determining that green color information is not exposed from the teaching block 400 as a result of photographing the teaching block 400, as shown in FIG. 6C, the controller may determine that the rotation amount of the welding gun 100 with respect to the −x-axis has been completely corrected.

In the same manner, as shown in FIG. 7A, upon determining that a third color of the side surface 440, for example, blue color information, is exposed from the teaching block 400 with reference to the image information received from the image capturing apparatus 300 (refer to FIG. 5), the controller 500 performs a control operation to correct the rotation amount of the welding gun 100 with respect to the +y-axis.

Here, when the controller 500 corrects the rotation amount of the welding gun 100 with respect to the +y-axis, repetitive control may be performed. As shown in FIG. 7B, in a state in which the rotation amount of the welding gun 100 with respect to the +y-axis correction is corrected, upon determining that bule color information is not exposed from the teaching block 400 as a result of photographing the teaching block 400, as shown in FIG. 7C, the controller may determine that the rotation amount of the welding gun 100 with respect to the +y-axis has been completely corrected.

Additionally, as shown in FIG. 7A, upon determining that a fourth color of the side surface 450, for example, orange color information, is exposed from the teaching block 400 with reference to the image information received from the image capturing apparatus 300 (refer to FIG. 5), the controller 500 performs a control operation to correct the rotation amount of the welding gun 100 with respect to the −y-axis.

Here, when the controller 500 corrects the rotation amount of the welding gun 100 with respect to the −y-axis, repetitive control may be performed. As shown in FIG. 7B, in a state in which the rotation amount of the welding gun 100 with respect to the −y-axis is corrected, upon determining that orange color information is not exposed from the teaching block 400 as a result of photographing the teaching block 400, as shown in FIG. 7C, the controller may determine that the rotation amount of the welding gun 100 with respect to the −y-axis has been completely corrected.

Preferably, the controller 500 may alternately perform a control operation to correct the rotation amount of the welding gun 100 with respect to the x-axis and the rotation amount of the welding gun 100 with respect to the y-axis. Further, the controller may also perform a control operation to correct the rotation amount of the welding gun 100 with respect to the y-axis in a state in which the rotation amount of the welding gun 100 with respect to the x-axis is completely corrected.

In this manner, in order to correct straightness of the panel 1, the controller may perform a control operation to correct the rotation amount of the welding with respect to the x-axis and the rotation amount of the welding gun 100 with respect to the y-axis using the first to fourth colors, but this control method is only one embodiment, and the present disclosure is note limited thereto. In addition, by applying different QR codes or barcodes, Aruco markers, and the like to the side surfaces 420, 430, 440, and 450 of the teaching block 400, a control operation may be performed to correct the rotation amount of the welding gun 100 with respect to the x-axis and the rotation amount of the welding gun 100 with respect to the y-axis through the same control method using the image capturing apparatus 300.

In addition, as shown in FIG. 8A, in a state in which the shape of a center point 410a formed on the reference surface 410 includes a guide area 412, the controller 500 may control, upon determining that the guide area has been rotated from the set initial position through the image information received from the image capturing apparatus 300, position correction such that the welding gun 100 is rotated about the z-axis.

In other words, as shown in FIG. 8B, upon determining that the welding gun 100 needs to be rotated through an angular difference (refer to FIG. 8A) between a guide area 412′ of a reference surface 410′ included in the image information and the guide area 412 of the reference surface 410, the controller 500 may calculate the rotation amount of the welding gun 100 with respect to the z-axis, such as 45°.

In addition, as shown in FIG. 8B, the controller 500 may correct, with reference to the image information, the upward or downward movement position of the welding gun 100 by calculating a ratio (refer to FIG. 8A) of a length between a pair of protrusions 410′b provided on the reference surface 410′ to a length between a pair of protrusions 410b provided on the reference surface 410.

More specifically, referring to FIG. 8C, the controller 500 may calculate a length ratio of 0.5 when the length between the pair of protrusions 410b is 10 mm and the length between the pair of protrusions 410′b is 0.5 mm (refer to FIGS. 8A and 8B). Further, a ratio measurement distance λ may be calculated by a calculation formula of “1/length ratio*reference distance a” though the length ratio. Additionally, a movement distance may be calculated through the calculation formula of “movement distance d=ratio measurement distance λ−reference distance a”. As a result, the height of the welding gun 100 may be corrected such that the welding gun is moved upwards or downwards along the z-axis by the movement distance toward the teaching block 400.

Meanwhile, as shown in FIG. 11A, the resistance spot welding device according to the present embodiment may further include a straightness inspection jig 600.

The straightness inspection jig 600 is provided to inspect straightness between the upper electrode 102 and the lower electrode 104 in real time by being introduced into the welding gun 100 in a state in which any one of the welding points is completely welded.

To this end, as shown in FIG. 11B, the straightness inspection jig 600 includes a first mounting part 610, a second mounting part 620, a first sensor part 630, and a second sensor part 640.

The first mounting part 610 is formed to be rotatable and has a first through hole H1 formed therein and configured to allow the electrode tip of the upper electrode 102 to pass therethrough.

In addition, the second mounting part 620 is disposed to face the first mounting part 620. The second mounting part is formed to be rotatable and has a second through hole H2 positioned to extend in the vertical direction from the first through hole H1 and configured to allow the electrode tip of the lower electrode 104 to pass therethrough.

Additionally, the first sensor part 630 provides, depending on selective rotation of the first mounting part 610, a signal about poor straightness of the upper electrode 102, and the second sensor part 640 provides, depending on selective rotation of the second mounting part 620, a signal about poor straightness of the lower electrode 104.

Through this configuration, when the upper electrode 102 and the lower electrode 104 of the welding gun 100 respectively pass through the first through hole H1 and the second through hole H2 in real time, the controller 500 determines that the straightness between the upper electrode 102 and the lower electrode 104 is normal. On the other hand, when it is determined that at least one of the upper electrode 102 or the lower electrode 104 of the welding gun 100 is caught in the first through hole H1 or the second through hole H2 such that a sensor signal of the first sensor part 630 or the second sensor part 640 is detected from the controller 500, the controller 500 determines that straightness therebetween is poor.

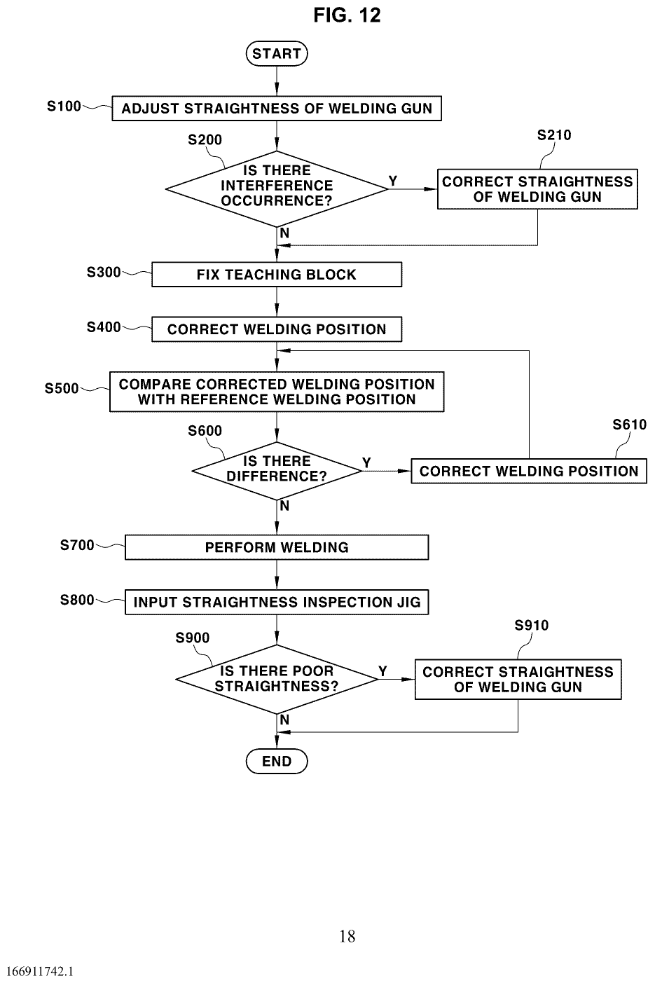

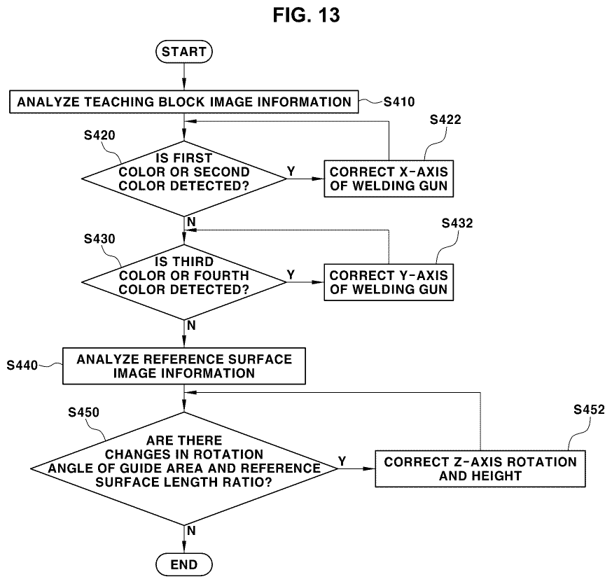

Hereinafter, FIG. 12 is a flowchart sequentially showing a resistance spot welding method according to another embodiment of the present disclosure, and FIG. 13 is a flowchart sequentially showing correction of the welding position in the resistance spot welding method according to another embodiment of the present disclosure.

As shown in FIG. 12, the resistance spot welding method according to the present embodiment is sequentially described as follows.

First, straightness between the upper electrode and the lower electrode each forming the welding gun 100 is adjusted through the adjustment jig 200 (S100).

To this end, in a state in which the electrode tip of the lower electrode 104 is fixedly inserted into the first fixing part 210 of the adjustment jig 200, the pressure actuator 120 is moved downward such that the electrode tip of the upper electrode 102 is positioned in the second fixing part 220 formed to be integrated with the first fixing part 210.

Here, when the electrode tip of the upper electrode 102 is positioned in the second fixing part 220 without interference therebetween, it is determined that the straightness is satisfied (S200). On the other hand, when interference occurs, the position of the electrode tip of the upper electrode 102 is adjusted so as to be positioned in a straight line with the electrode tip of the lower electrode 104 (S210).

When the electrode tip of the upper electrode 102 and the electrode tip of the lower electrode 104 are not positioned in the straight line, welding is performed in a state in which the upper electrode 102 and the lower electrode 104 are not aligned with each other. Accordingly, when straightness between the upper electrode 102 and the lower electrode 104 is satisfied through the adjustment jig 200 before welding is performed, spatter generation may be prevented during welding.

Next, when it is determined that the straightness between the upper electrode 102 and the lower electrode 104 is satisfied (S200), the teaching block 400 is mounted on the welding point (S300), and the controller 500 calculates the rotation amount and the movement amount of the welding gun 100 based on image information on the teaching block 400 received from the image capturing apparatus 300. Thereafter, the controller performs a control operation to correct the welding position of the welding gun 100 such that the welding point and the welding gun 100 are positioned in a straight line (S400).

That is, as shown in FIG. 13, the controller 500 analyzes the image information on the teaching block 400 received from the image capturing apparatus 300 (S410).

In this case, upon determining that the first color of the side surface 420, for example, purple color information, is exposed from the teaching block 400 with reference to the image information (S420), the controller 500 performs a control operation to correct the rotation amount of the welding gun 100 with respect to the +x-axis (S422). Further, upon determining that the second color, for example, green color information, is exposed from the teaching block 400 with reference to the image information (S420), the controller 500 performs a control operation to correct the rotation amount of the welding gun 100 with respect to the −x-axis (S422).

As described above, in a state in which the correction control of the welding gun 100 with respect to the x-axis is completed, upon determining that the third color of the side surface 440, for example, blue color information, is exposed from the teaching block 400 with reference to the image information (S430), the controller 500 performs a control operation to correct the rotation amount of the welding gun 100 with respect to the +y-axis (S432). Further, upon determining that the fourth color, for example, orange color information, is exposed from the teaching block 400 with reference to the image information (S430), the controller 500 performs a control operation to correct the rotation amount of the welding gun 100 with respect to the −y-axis (S432).

Here, as described above, referring to the accompanying drawings, the controller 500 performs a control operation to correct the rotation amount of the welding gun 100 with respect to the y-axis in a state in which the rotation amount of the welding gun 100 with respect to the x-axis is corrected, but the present disclosure is not limited thereto. The rotation amount of the welding gun 100 with respect to the x-axis and the rotation amount of the welding gun 100 with respect to the y-axis may be alternately corrected.

In addition, as described above, although the controller 500 performs a control operation to correct the rotation amount of the welding gun 100 with respect to the x-axis and the rotation amount of the welding gun 100 with respect to the y-axis using the first to fourth colors, the present disclosure is not limited thereto. In addition, by applying different QR codes or barcodes, Aruco markers, and the like to the side surfaces 420, 430, 440, and 450 of the teaching block 400, a control operation may be performed to correct the rotation amount of the welding gun 100 with respect to the x-axis and the rotation amount of the welding gun 100 with respect to the y-axis through the same control method using the image capturing apparatus 300.

Next, the controller 500 analyzes the image information of the reference surface 410 (S440). Upon determining that a rotation angle of the guide area 412 of the reference surface 410 and a length between a pair of protrusions 410b provided on the reference surface 410 have changed (S450), the controller 500 performs a control operation to correct the rotation amount of the welding gun 100 and the height of the welding gun 100 with respect to the Z-axis (S452).

That is, as shown in FIG. 8A, in a state in which the shape of the center point 410a formed on the reference surface 410 includes the guide area 412, the controller 500 may control, upon determining that the guide area has been rotated from the set initial position through the image information received from the image capturing apparatus 300, position correction such that the welding gun 100 is rotated about the z-axis.

In other words, as shown in FIG. 8B, upon determining that the welding gun 100 needs to be rotated through an angular difference (refer to FIG. 8A) between the guide area 412′ of the reference surface 410′ included in the image information and the guide area 412 of the reference surface 410, the controller 500 may calculate the rotation amount of the welding gun 100 with respect to the z-axis, such as 45°.

In addition, as shown in FIG. 8B, the controller 500 may correct, with reference to the image information, the upward or downward movement position of the welding gun 100 by calculating a ratio (refer to FIG. 8A) of a length between a pair of protrusions 410′b provided on the reference surface 410′ to a length between a pair of protrusions 410b provided on the reference surface 410.

More specifically, referring to FIG. 8C, the controller 500 may calculate a length ratio of 0.5 when the length between the pair of protrusions 410b is 10 mm and the length between the pair of protrusions 410′b is 0.5 mm (refer to FIGS. 8A and 8B). Further, a ratio measurement distance λ may be calculated by a calculation formula of “1/length ratio*reference distance a” though the length ratio. Additionally, a movement distance may be calculated through the calculation formula of “movement distance d=ratio measurement distance λ−reference distance a”. As a result, the height of the welding gun 100 may be corrected such that the welding gun is moved upwards or downwards along the z-axis by the movement distance toward the teaching block 400.

In this manner, when the welding position of the welding gun 100 is corrected (S400), the controller 500 compares the corrected welding position with the reference welding position (S500).

Here, the reference welding position may be stored in a separate welding position inspection system (not shown). Here, when information on the corrected welding position is input to the welding position inspection system (not shown), a difference between the stored reference welding position and the corrected welding position may be detected based on information on an actual design drawing, such as tool center point ((TCP) serving as the center coordinate of a robot tool (welding gun), that is, the actual welding position center) data.

For example, upon determining that the difference between the corrected welding position and the reference welding position is equal to or greater than a set value (for example, 20% or more) (S600), the controller 500 corrects the welding position of the welding 100 such that the corrected current welding position follows the reference welding position (S610).

At this time, when the controller 500 determines that the corrected welding position and the reference welding position almost coincide with each other, that is, the difference therebetween is almost zero, information on the corresponding welding position is finally saved as TCP data. Then, the controller 500 controls the welding gun 100 such that a high current is generated between the electrode tip of the upper electrode 102 and the electrode tip of the lower electrode 104, thereby performing welding on the welding point (S700).

Here, the controller determines whether the TCP data has changed in real time. Upon determining that the TCP data has changed, the controller 500 corrects the welding position of the welding gun 100 such that the changed current welding position follows the reference welding position (S610).

Thereafter, in a state in which welding is completely performed at any one of the plurality welding points, the straightness inspection jig 600 is inserted into a space between the electrode tips (S800) so as to inspect straightness between the upper electrode 102 and the lower electrode 104.

Upon determining that at least one of the upper electrode 102 or the lower electrode 104 of the welding gun 100 is caught in the first through hole H1 or the second through hole H2 of the straightness inspection jig 600 such that a sensor signal of the first sensor part 630 or the second sensor part 640 is detected accordingly, the controller 500 determines that straightness therebetween is poor (S900).

To this end, the straightness between the upper electrode 102 and the lower electrode 104 is repeatedly corrected such that the sensor signal from the first sensor part 630 or the second sensor part 640 is not detected (S910). Then, when the straightness between the upper electrode 102 and the lower electrode 104 is corrected in this manner, welding is performed for another welding point on the welding surface (refer to FIG. 3A),

A resistance spot welding device according to the present disclosure secures straightness between an upper tip and a lower tip of a welding gun using an adjustment jig, performs position correction of the welding gun using a camera in a state in which a block is fixed to a panel, and performs welding in a state in which pressing force applied to the welding surface is equally applied to the upper tip and the lower tip through an air balance cylinder mounted on the welding gun such that balance of pressing force is maintained in the upper and lower tips, thereby having an effect of preventing spatter generation due to an increase in resistance heat caused by a change in pressing force.

Here, in the related art, management personnel and costs are excessively invested in welding quality control at a completed vehicle factory, resulting in a decrease in profitability of the completed vehicle factory. However, according to the present disclosure, quality deterioration caused by spatter may be fundamentally solved by improving straightness and pressing force of the welding gun, thereby having an effect of preventing a decrease in profitability of the completed vehicle factory.

As is apparent from the above description, the present disclosure provides a resistance spot welding device and a resistance spot welding method capable of securing straightness between an upper tip and a lower tip of a welding gun using an adjustment jig, correcting the position of the welding gun using a camera in a state in which a block is fixed to a panel, and performing welding in a state in which pressing force applied to the welding surface is equally applied to the upper tip and the lower tip through an air balance cylinder mounted on the welding gun such that balance of pressing force is maintained in the upper and lower tips, thereby having an effect of preventing spatter generation due to an increase in resistance heat caused by a change in pressing force.

Additionally, in the related art, profitability of a completed vehicle factory decreases due to excessive management personnel and costs invested in welding quality control. However, according to the present disclosure, deterioration in welding quality caused by spatter generation may be fundamentally solved by improving straightness between the upper and lower tips of the welding gun and pressing force of the welding gun, thereby having an effect of preventing a decrease in profitability of the completed vehicle factory.

The present disclosure has been described in detail with reference to preferred embodiments shown in the drawings, but the embodiments are merely illustrative. It will be appreciated by those skilled in the art that various modifications may be made from the embodiments, and all or a part of the embodiments may be selectively combined with each other. Therefore, the true technical protection scope of the present disclosure should be defined by the technical spirit of the appended claims.

What is claimed is:

1. A resistance spot welding device for vehicle assembly, the resistance spot welding device comprising:
a welding gun;
an adjustment jig configured to adjust positioning of the welding gun;
an image capturing apparatus mounted on the welding gun and configured to photograph a welding surface;
teaching blocks respectively mounted on a plurality of welding points formed on the welding surface; and
a controller configured to calculate, through image information on each of the teaching blocks received from the image capturing apparatus, a rotation amount and a movement amount of the welding gun, and to perform a control operation to correct a welding position of the welding gun based on the calculated rotation amount and movement amount.

2. The resistance spot welding device of claim 1, wherein each of the teaching blocks is formed to have a hexahedral shape comprising a reference surface positioned in a direction facing the image capturing apparatus and a mounting surface positioned at the welding point on the welding surface, and four side surfaces connecting the reference surface to the mounting surface are respectively formed to have different pieces of color information.

3. The resistance spot welding device of claim 2, wherein the controller is configured to perform, upon determining that any one of a first color and a second color facing each other on the side surfaces is comprised in the image information, a control operation to correct the welding position such that the welding gun is rotated about a +x-axis or a −x-axis relative to a center point of the reference surface.

4. The resistance spot welding device of claim 3, wherein the controller is configured to perform, upon determining that any one of a third color and a fourth color facing each other on the side surfaces is comprised in the image information, a control operation to correct the welding position such that the welding gun is rotated about a +y-axis or a −y-axis relative to the center point of the reference surface.

5. The resistance spot welding device of claim 2, wherein the controller is configured to perform, upon determining that a shape of a center point formed on the reference surface comprises a guide area such that the guide area is rotated from a set initial position, position correction such that the welding gun is rotated about a +z-axis or a −z-axis.

6. The resistance spot welding device of claim 2, wherein the controller is configured to calculate a length ratio by comparing a measurement length between protrusions respectively formed at opposite corners on the reference surface with a reference measurement length, and to correct, using the calculated length ratio, an upward movement position or a downward movement position of the welding gun.

7. The resistance spot welding device of claim 1, wherein the welding gun comprises an upper electrode and a lower electrode, and the adjustment jig is configured to adjust straightness between the upper electrode and the lower electrode.

8. The resistance spot welding device of claim 7, wherein the adjustment jig comprises:
a first fixing part configured to fix an electrode tip of the lower electrode; and
a second fixing part configured to allow an electrode tip of the upper electrode to be introduced thereinto in a state in which the electrode tip of the lower electrode is fixed to the first fixing part, wherein the second fixing part is configured to adjust, based on determination of presence or absence of interference between the electrode tip of the upper electrode and the second fixing part, the straightness between the upper electrode and the lower electrode.

9. The resistance spot welding device of claim 7, wherein the controller is configured to control, when the upper electrode is moved downwards, pneumatic pressure supplied to a balance cylinder so as to apply preset gravitational force to the welding surface, and to cause, when the welding gun comprising the lower electrode is moved upwards, reaction force equal to the preset gravitational force to be applied to the welding surface.

10. The resistance spot welding device of claim 7, further comprising a straightness inspection jig introduced into the welding gun in a state in which the welding point is completely welded, the straightness inspection jig being configured to inspect the straightness between the upper electrode and the lower electrode.

11. The resistance spot welding device of claim 10, wherein the straightness inspection jig comprises:
a first mounting part formed to be rotatable, the first mounting part having a first through hole provided therein and configured to allow an electrode tip of the upper electrode to pass therethrough;
a second mounting part disposed to face the first mounting part and formed to be rotatable, the second mounting part having a second through hole positioned to extend in a vertical direction from the first through hole, the second through hole being configured to allow an electrode tip of the lower electrode to pass therethrough;
a first sensor part configured to provide, depending on selective rotation of the first mounting part, a signal about poor straightness of the upper electrode; and
a second sensor part configured to provide, depending on selective rotation of the second mounting part, a signal about poor straightness of the lower electrode.

12. A resistance spot welding method for vehicle assembly, the resistance spot welding method comprising:
a straightness adjustment step of adjusting, by an adjustment jig, straightness between an upper electrode and a lower electrode each forming a welding gun;
a welding gun position correction step of mounting a teaching block on a welding point formed on a welding surface when the straightness between the upper electrode and the lower electrode is determined to be satisfied, and calculating, by a controller, a rotation amount and a movement amount of the welding gun through image information on the teaching block received from an image capturing apparatus so as to correct a welding position of the welding gun;
a welding point position comparison step of comparing, when the corrected welding position of the welding gun is transmitted to the controller, a difference between the welding position and a reference welding position previously stored in the controller; and
a welding step of controlling, by the controller, the welding gun when the welding position and the reference welding position coincide with each other and performing welding on the welding point.

13. The resistance spot welding method of claim 12, wherein the straightness adjustment step comprises:
a first step of fixing an electrode tip of the lower electrode through a first fixing part formed on one side of the adjustment jig; and
a second step of allowing an electrode tip of the upper electrode to be introduced into a second fixing part formed on the other side of the adjustment jig in a state in which the electrode tip of the lower electrode is fixed to the first fixing part, and adjusting, based on determination of presence or absence of interference between the electrode tip of the upper electrode and the second fixing part, the straightness between the upper electrode and the lower electrode.

14. The resistance spot welding method of claim 12, wherein, in the welding gun position correction step,
the teaching block is formed to have a hexahedral shape comprising a reference surface positioned in a direction facing the photographing means and a mounting surface positioned at the welding point on the welding surface, and the controller corrects the rotation amount of the welding gun using different pieces of color information respectively comprised in four side surfaces of the teaching block.

15. The resistance spot welding method of claim 14, wherein, in the welding gun position correction step,
the controller is configured to perform, upon determining that any one of a first color and a second color facing each other on the side surfaces is comprised in the image information, position correction such that the welding gun is rotated about a +x-axis or a −x-axis relative to a center point of the reference surface, and
the controller is configured to perform, upon determining that any one of a third color and a fourth color facing each other on the side surfaces is comprised in the image information, position correction such that the welding gun is rotated about a +y-axis or a −y-axis relative to the center point of the reference surface.

16. The resistance spot welding method of claim 14, wherein, in the welding gun position correction step,
the controller is configured to perform, upon determining that a shape of a center point formed on the reference surface comprises a guide area such that the guide area is rotated from a set initial position, position correction such that the welding gun is rotated about a +z-axis or a −z-axis.

17. The resistance spot welding method of claim 12, wherein, in the welding gun position correction step,
the controller is configured to calculate a length ratio by comparing a measurement length between protrusions respectively formed at opposite corners on the reference surface with a reference measurement length, and to correct, using the calculated length ratio, an upward movement position or a downward movement position of the welding gun.

18. The resistance spot welding method of claim 12, further comprising a straightness inspection step of inspecting, using a straightness inspection jig introduced into the welding gun, the straightness between the upper electrode and the lower electrode in a state in which the welding point is completely welded.

19. The resistance spot welding method of claim 18, wherein, in the straightness inspection step,
an electrode tip of the upper electrode is allowed to pass through a first through hole of a first mounting part, and the straightness inspection jig provides, when the first mounting part is rotated and disposed to face a first sensor part, a signal about poor straightness of the upper electrode, and
an electrode tip of the lower electrode is allowed to pass through a second through hole of a second mounting part, and the straightness inspection jig provides, when the second mounting part is rotated and disposed to face a second sensor part, a signal about poor straightness of the lower electrode.

20. A vehicle assembly process comprising the resistance spot welding method of claim 12.
